(19) United States
(12) Patent Application Publication
(10) Pub. No.: US 2010/0163309 A1
(43) Pub. Date: Jul. 1, 2010

(54) Sub-Surface Deployment Valve

(76) Inventor: Philip Head, Surrey (GB)

Correspondence Address: NIXON & VANDERHYE, PC, 901 NORTH GLEBE ROAD, 11TH FLOOR, ARLINGTON, VA, 22203, US

(21) Appl. No.: 11/991,857

(22) PCT Filed: Sep. 7, 2006
(86) PCT No.: PCT/GB2006/003306

§ 371 Date: Mar. 12, 2008

(30) Foreign Application Priority Data
Sep. 21, 2005 (GB) 0519287.7

(51) Int. Cl. E21B 7/24; F16K 27/00

(52) U.S. Cl. 175/55; 251/356

(57) ABSTRACT

A sub surface deployment valve which is particularly suitable for use in underbalanced drilling operations which can be installed through an existing tubular string comprises a radially expandable body (1) having an internal bore and a valve element (2) capable of closing off the internal bore. The deployment valve can be installed by passing the valve through the existing tubular and then radially expanding the radially expandable body of the deployment valve to form a connection resulting from the interference between the external surface of the deployment valve and the tubular string.

This application is the U.S. national phase of International Application No. PCT/GB2006/003306 filed 7 Sep. 2006 which designated the U.S. and claims priority to Great Britain Application No. 0519287.7 filed 21 Sep. 2005, the entire contents of each of which are hereby incorporated by reference.

The present invention relates to a sub-surface deployment valve suitable for use in underbalanced drilling. In particular, the invention relates to apparatus and methods for installing and using a sub-surface deployment valve which can be installed through an existing tubular string in an oil or gas well.

In conventional rotary drilling methods a wellbore is drilled by rotating a drill bit to which downward force is applied. The drill bit is attached to and rotated by a drill string which has a passageway through which a drilling fluid is circulated. The drilling fluid, usually called drilling mud, is generally circulated down the well through the passageway in the drill string, over the drill bit and returns to the surface through an annular space between the drill string and the wellbore wall. The drilling mud may however be circulated in the reverse direction. The drilling mud has a number of functions, including cooling and lubricating the drill bit and drill string, transporting drill cuttings from the bottom of the borehole to the surface, protecting against blowouts by holding back subsurface pressures and depositing a mud cake on the wall of the borehole to prevent loss of fluids to the formation. When drilling through a formation which does not contain a fluid, such as water, gas or oil, the weight and the pumping rate of the drilling mud are selected so that the pressure at the wellbore wall is maintained between a lower pressure at which the wellbore becomes unstable and an upper pressure at which the wellbore wall is fractured. When the wellbore is drilled through a fluid-containing zone, the drilling mud pressure is generally selected to be above the pressure at which fluid starts flowing into the wellbore (formation pressure), and below the pressure at which undesired invasion of drilling mud into the formation occurs. This is generally referred to as overbalanced drilling.

Drilled wellbores are generally lined with tubular strings, usually steel pipe, referred to as casing. The casing provides support to the wellbore and facilitates the isolation of certain sections of the wellbore adjacent hydrocarbon bearing formations. The casing typically extends down the wellbore from the surface of the well and the annulus between the outside of the casing and the borehole wall is typically, but not necessarily, filled with cement to permanently set the casing in the wellbore.

As the wellbore is drilled to a new depth, additional strings of pipe are run into the well to that depth whereby the upper portion of the string of pipe (often referred to as “liner”), is overlapping the lower portion of the casing. The liner is then fixed or hung in the wellbore, usually by some mechanical slip means well known in the art.

The known overbalanced rotary drilling methods have long been recognized as safe methods for drilling a well. However, a significant disadvantage of such methods is that since the drilling mud pressure is higher than the natural formation pressure, fluid invasion frequently occurs, causing permeability damage to the formation.

Underbalanced drilling differs from the more conventional overbalanced drilling in that the bottomhole circulating pressure is lower than the formation pressure, thereby permitting the well to flow while drilling proceeds. Thus, when drilling through a formation containing oil or gas, production can be obtained from a well prior to completion. Underbalanced drilling can also be used in formations containing other fluids, such as water. In this specification, the term “reservoir formation” is used to denote any rock or earth formation that contains a fluid under pressure.

Advantages that have been claimed for underbalanced drilling include:
Maintaining wellbore pressure below the reservoir pressure allows reservoir fluids to enter the wellbore, thus avoiding formation damage. Since significant formation damage is avoided, the stimulation requirements during well completion are also reduced, leading to considerable savings.
During underbalanced drilling there is no physical mechanism to force drilling fluid into the drilled formation. Therefore, lost circulation is kept to a minimum when fractured or high permeability zones are encountered.
Underbalanced drilling can help in detecting potential hydrocarbon zones, even identifying zones that would have been bypassed with conventional drilling methods.
Due to the decreased pressure at the drill bit head, underbalanced drilling operations can have superior penetration rates as compared to conventional overbalanced drilling techniques. Along with reduced drilling times, an increase in bit life has sometimes been reported.
Since there is no filter cake around the wellbore wall, the chances of differential sticking are also reduced.

Underbalanced drilling does however also have some disadvantages. For example, it can be more difficult to control the well in certain circumstances. In particular, problems may arise when it is necessary to remove the drill string from the well or to run it back into the well. Pressure in the wellbore is generally controlled at the surface, such as with a blow-out preventer (BOP). The weight of the drill string holds the drill string within the borehole. However, as sections of the drill string are removed, the drill sting becomes lighter until a depth is reached at which the upward forces acting on the drill string become greater than the downward forces. This depth is called the “string light point”. A number of factors affect where exactly in the borehole a drill string will become string light.

The person skilled in the art will be well aware that well bore depths may not be the same as vertical depth so that references to depths in the well bore such as “above” or “below” certain depths generally refer to well bore depths rather than vertical depths

With pressure at the surface of the wellbore, then at some point, as the drill string is removed, the pressure may begin to push or accelerate the remaining drill string out of the wellbore. This is a potentially dangerous situation which could result in a blow-out. If the upward movement of the pipe is not controlled, sufficient momentum may be developed such that the blow out preventer is unable to contain the upward movement. Attempting to close the rams may result in damage to the rams or even their being torn out rather than them arresting the upward movement of the drill pipe. In such a situation, the rams may not be able to shut-in the well after the pipe has been pushed from the well bore.

Methods are known to avoid a blow-out situation. For example, it may be possible to bleed off the surface pressure prior to reaching the string light point. However, reliance on this method can be risky. It is possible for a bridge to form in the formation such that it appears that there is a bleed off of pressure. If the bridge breaks at the wrong moment with the drill pipe almost out of the hole, then significant formation pressure may be applied at the surface resulting in a blow-out.

A very effective and safe practice is to kill the well prior to removal of the drill string, i.e. introduce drilling fluid to provide a pressure in the wellbore which is greater than the formation pressure. However, this practice is undesirable because advantages of underbalanced drilling may be lost. In particular, formation damage may occur as a result of the pressure of the drilling fluids used to kill the well which may be substantially or partially irreversible.

Another very effective and safe practice is to use a so-called snubbing unit for removing the drill string. A snubbing unit provides a means for removing and inserting tools and tubulars into wells under pressure and ensures that the wells can be safely serviced without having to use kill weight with fluids. However, it takes a significant amount of time and effort to install a snubbing unit, trip the drill string and uninstall the snubbing unit resulting in increased drilling costs.

U.S. Pat. No. 6,209,663 discloses apparatus and methods for a deployment valve used with an underbalanced drilling system. The deployment valve is positioned in a tubular string, such as casing, at a wellbore depth at or preferably substantially below the string light point of the drill string. The deployment valve has a bore sufficiently large to allow passage of the drill bit therethrough when in the open position. The deployment valve may be closed when the drill string is pulled within the casing. To allow the drill string to be removed from the casing, the pressure produced by the formation can be bled off and the drill sting removed. The drill string can be reinserted, the pressure in the casing above the deployment valve applied to preferably equalize the pressure above and below the deployment valve and the drill string run into the hole. The deployment valve is run in as an integral part of the casing program. Thus, the deployment valve can be secured to the casing and run in with it or may be mounted within the casing by running a smaller tubular string inside the casing.

Sometimes the interior of the initial wellbore has one or more restrictions along its length that reduce the cross-sectional area of the wellbore. For example, the wellbore may have a string of production tubing that is carried concentrically within the main wellbore and that is of a smaller internal diameter than the wellbore or any casing lining the wellbore. Typically, the wellbore has an internal diameter of about 5 inches (12.7 cm) to about 10 inches (25.4 cm), for example 7 inches (17.8 cm) and the production tubing has an internal diameter of about 2.5 inches (6.4 cm) to about 6 inches (15.2 cm), for example 4.5 inches (11.4 cm). This means that any tool that is passed down the interior of that well bore, including a drill string and drill bit, has to be small enough in cross-section to pass through the restriction in order to reach lower levels in the wellbore. This is called through-tubing operations in that any well operations that are to be carried out in the well bore below the end of the production tubing require the equipment to be passed through the interior of the production tubing before it can reach the area where the well operation is to be carried out. The alternative would be to remove the production tubing in its entirety from the well bore, which is an expensive and time consuming process. Thus, it is very desirable to be able to pass well tools that are to be used in well operations through the interior of the smaller diameter production tubing down below the end of that tubing into the larger diameter wellbore and then carrying out well operations with those tools in that larger area of the wellbore.

It would be useful to be able to install a sub-surface deployment valve at the end of a restriction in the diameter of a wellbore or below such a restriction in a wellbore by running the deployment valve down through the restriction and in particular, it would be useful to be able to install a sub-surface deployment valve at the end of a production tube or below the production tube by running the deployment valve down through the production tubing. Such a deployment valve could provide a means for more safely and/or more quickly removing a drill string from a tubular string, such as a casing string or production tube, when the tubular string is exposed to relatively high formation pressure. However, such a deployment valve should preferably reduce the available bore as little as possible.

Thus according to the present invention, a sub-surface deployment valve comprises a radially expandable body having an internal bore and a valve element capable of closing off the internal bore.

The sub-surface deployment valve, hereinafter deployment valve, is dimensioned such that it can pass through a restriction in a wellbore and is sufficiently radially expandable that it can thereafter be expanded, such that the expanded internal bore is preferably not significantly smaller than the dimensions of the restriction, preferably, the internal bore is not more than 10% smaller than the dimensions of the restriction. Where the restriction is production tubing, the deployment valve may, by careful design and installation, have an internal bore after expansion which is substantially the same as the internal bore of the production tubing.

The valve element is operable to open or close the internal bore of the deployment valve. Any suitable valve element can be used, including an inflatable seal, a flapper valve element, a ball valve or other rotatable closure element or telescoping closure elements.

An embodiment of the deployment valve comprises a radially expandable tubular body having a flapper valve element attached to the expandable tubular body at one end thereof by pivot connections. The expandable tubular body preferably has a folded or deformed wall at least adjacent the flapper valve element such that the pivot means and flapper valve element can be arranged to minimize the projected size of the deployment valve. For example, the pivot means may be accommodated within the folded wall and may support the flapper valve element in the open position, such that its widest dimension is positioned towards the central axial plane of the tubular body.

In a more preferred embodiment, the flapper valve element is deformable so that it can be passed through a tube of smaller diameter. This deformability can be achieved by the design of the flapper valve element and/or the material of construction. In one embodiment the flapper valve element comprises a sealing surface and a reinforcing portion which is attached to or integrally formed with the sealing surface. The reinforcing portion can comprise substantially parallel ribs the longitudinal axis of which are in the same axis as the longitudinal axis of the tubular body, when the valve element is in the open position. The reinforcing portion can be, for example, a block with substantially parallel slots to form the ribs or can be a series of substantially parallel bars mounted close together forming the ribs. The slots or gaps between the ribs allow the valve element to be deformed. The flapper valve element can be machined from a single piece of material, e.g. by cutting substantially parallel slots in the material. In another embodiment, reinforcing elements can be fixed, e.g. by welding, to one side of a relatively thin plate; the other side of the plate acts as or supports the sealing surface. Another option is to mould the flapper valve element from a suitable moldable material that is inert to the reservoir fluids. The substantially parallel ribs allow the valve element to be deformed, bringing the outer edges of valve element towards each other, thereby reducing the maximum dimension of the valve element transverse to the longitudinal axis of the tubular body of the deployment valve.

It may be possible to deform the flapper valve element as the deployment valve is being introduced into the wellbore at the surface. In another option, the flapper plate element may be deformed and held in the deformed position by a restraining means until after the deployment valve is installed and then the restraining means can be released. For example, the flapper valve element, which in operation may be substantially flat, may be deformed into a curve and restrained by being placed into a tube or by a strap preventing the curved edges from opening. Once downhole, the restraining tube or strap would be removed to allow the flapper valve element to open out.

Expandable tubulars for use in wellbores are known, as are means for expanding such tubulars. The expansion can be accomplished by a mandrel or a cone-shaped member urged through the tubular that is to be expanded or by any other suitable expander tool.

Although any of the known methods of radially expanding the expandable valve body can be used in the present invention, a preferred method is to use a rotating ball or roller expander. Such devices are known and comprise radially extendible rotatable balls or rollers. The balls or rollers are urged outwardly against the internal wall of the expandable valve body and then the balls or rollers are rotated around the internal surface and are also moved axially along the valve body so that they describe a helical path.

The deployment valve may be hydraulically operated and have at least one hydraulic line for controlling movement of the deployment valve element. A biasing means such as a spring or weight or other control lines may be used to keep the valve element in the open or closed position. In one embodiment, the deployment valve has a spring element to bias closed a flapper valve element and seal it against a sealing surface on the deployment valve body and the flapper valve element can be opened by the weight of the drill string bearing down on the flapper valve element as the drill string is lowered into the well and/or pressure above the flapper valve. Operation of the valve element can also be effected through interaction between the drill string and the deployment valve such as, for example, vertical or rotational movement of the drill string acting on a movable element of the deployment valve.

The present invention includes a method for drilling a wellbore having located within the wellbore a tubular string, which method comprises positioning a deployment valve at least partially within the tubular string such that, once the valve is installed, a drill string can be moved through the valve wherein the deployment valve comprises a radially expandable body with an internal bore and a valve element capable of closing off the internal bore, the method further comprising attaching the deployment valve to or in the tubular string by radially expanding the radially expandable body of the deployment valve to form a connection resulting from the interference between the external surface of the deployment valve and the tubular string.

The tubular string can be any of the tubulars routinely used in wells, including casing, liner and production tubing, but is particularly useful for use in production tubing.

The invention of the present invention can be used with drilling operations that use rotary drills connected to the surface by a tubular drill string. It is also possible to use the invention in wireline drilling operations. A combination of wire line and tubular drill string may also be used. For example, a wireline can be run from the surface to a sub-surface housing for a motor that is capable of driving a tubular drill string having at its distal end a drill bit.

Although the method and apparatus according to the present invention are particularly useful in underbalanced drilling, it will be appreciated that the deployment valve may find other uses, including drilling even when the well is overbalanced for additional well control or even non-drilling operations. For example, the use of the deployment valve can provide a relatively long “lubricator” for deploying long or complex bottom hole assemblies. A lubricator is normally a specially fabricated length of pipe positioned around the surface of a borehole. It may be placed above a valve on top of the assembly of control valves, pressure gauges and chokes assembled at the top of a well to control the flow which is generally called the “Christmas tree” or may be placed above a valve on top of the casing or tubing head, but below the Christmas tree. The lubricator may have union connectors and bleed-off valves and provides a method of sealing off pressure yet still allow the passage of a device, usually on a wireline, or a substance, into the well, without having to kill the well. Once the well has been drilled, the deployment valve can be utilized for the deployment of the completion system, making it possible to run relatively long sections of completion tubulars such as expandable sand screen assemblies, slotted liner systems and production strings.

U.S. Pat. No. 6,305,469 discloses a method of underbalanced drilling which provides a method of creating a wellbore in an earth formation, the wellbore including a first wellbore section and a second wellbore section penetrating a hydrocarbon fluid bearing zone of the earth formation, the method comprising:
(a) drilling the first wellbore section;
(b) arranging a remotely controlled drilling device at a selected location in the first wellbore section, from which selected location the second wellbore section is to be drilled;
(c) arranging a hydrocarbon fluid production tubing in the first wellbore section in sealing relationship with the wellbore wall, the tubing being provided with fluid flow control means and a fluid inlet in fluid communication with said selected location;
(d) operating the drilling device to drill the new wellbore section whereby during drilling of the drilling device through the hydrocarbon fluid bearing zone, flow of hydrocarbon fluid from the second wellbore section into the production tubing is controlled by the fluid flow control means.

U.S. Pat. No. 6,305,469 discloses that the drilling device is releasably connected to the lower end of a hydrocarbon production tubing by a suitable connecting device. The hydrocarbon production tubing is then lowered into the casing until the drilling device is near the bottom of the first wellbore section whereafter the production tubing is fixed to the casing by inflating a packer which seals the annular space formed between the production tubing and the casing.

WO 2004/011766 discloses a method for underbalanced drilling using a remotely controlled drilling device that uses fluid produced from the formation to transport drill cuttings away from the cutting surfaces of the device in which the drilling device is capable of being passed from the surface to a selected location in an existing wellbore without having to pull the hydrocarbon fluid production tubing from the wellbore.

Thus, according to WO 2004/011766, a method of drilling a borehole from a selected location in an existing wellbore penetrating a subterranean earth formation having at least one hydrocarbon fluid bearing zone wherein the existing wellbore is provided with a casing and a hydrocarbon fluid production conduit is arranged in the wellbore in sealing relationship with the wall of the casing, comprises:
(a) passing a remotely controlled electrically operated drilling device from the surface through the hydrocarbon fluid production conduit to the selected location in the existing wellbore;
(b) operating the drilling device such that cutting surfaces on the drilling device drill the borehole from the selected location in the existing wellbore thereby generating drill cuttings wherein during operation of the drilling device, a first stream of produced fluid flows directly to the surface through the hydrocarbon fluid production conduit and a second stream of produced fluid is pumped over the cutting surfaces of the drilling device via a remotely controlled electrically operated downhole pumping means and the drill cuttings are transported away from the drilling device entrained in the second stream of produced fluid.

The method and apparatus according to the present invention can be utilized in processes such as those described in U.S. Pat. No. 6,305,469 and WO 2004/011766. For example, the deployment valve can be passed through the production tubing to a position at which the deployment valve is at least partially within the production tubing and then radially expanding the body of the deployment valve to attach the deployment valve to the end of the production tubing to form a connection resulting from the interference between the external surface of the deployment valve and the production tubing.

In the method of WO 2004/011766 a tubing can be provided to convey the second stream of produced fluid to the drill bit or to carry the fluid and drill cuttings away from the drill bit. This tubing may extend from the drill bit to the production tubing. The second wellbore can be quite long, e.g. in excess of 1 kilometre. The deployment valve according to the present invention can be used to create a lubricator length in the first wellbore to allow a long length of tubing to be safely introduced into the wellbore.

The invention will now be described with reference to the accompanying drawings in which:

FIG. 1 is a schematic sectional drawing of a deployment valve according to the present invention.

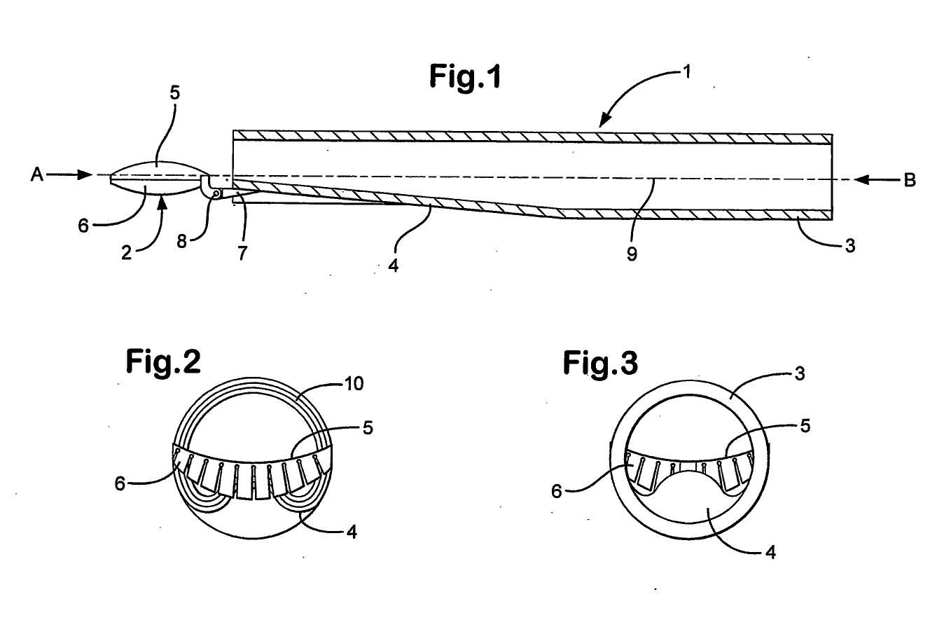

FIG. 2 is a schematic view in direction A of the deployment valve shown in FIG. 1, but not on the same scale.

FIG. 3 is a schematic view in direction B of the deployment valve shown in FIG. 1, but not on the same scale.

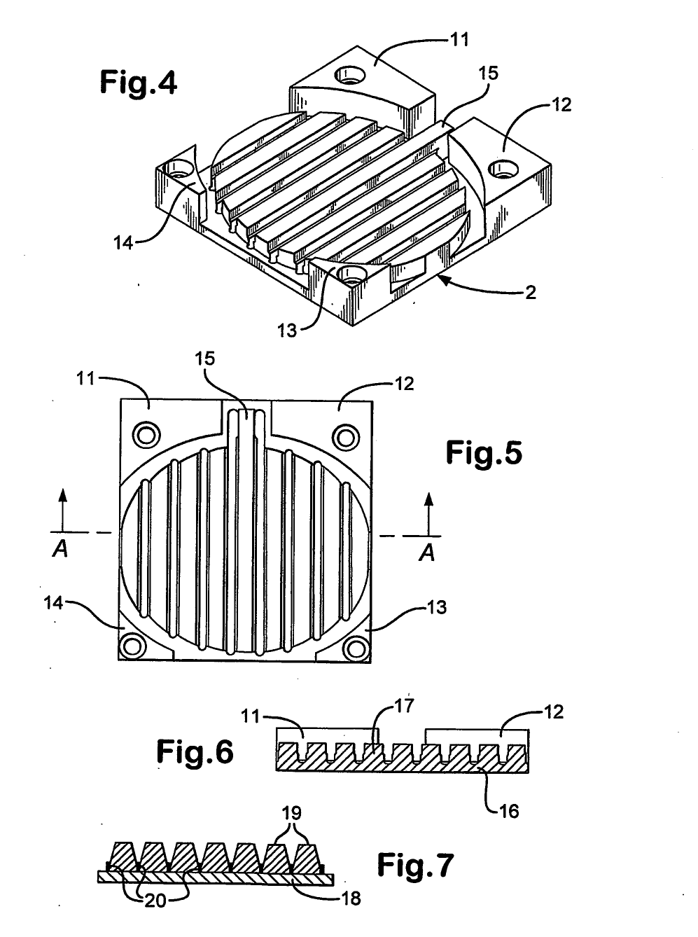

FIG. 4 is an isometric representation of a molded flapper valve element suitable for use in the present invention prior to cutting away the wastage.

FIG. 5 is a top view of the mould of FIG. 4.

FIG. 6 is a cross-section along AA of FIG. 5.

FIG. 7 is a cross-sectional illustration of a flapper valve element similar to that shown in FIGS. 4 to 6 except that it is produced by welding.

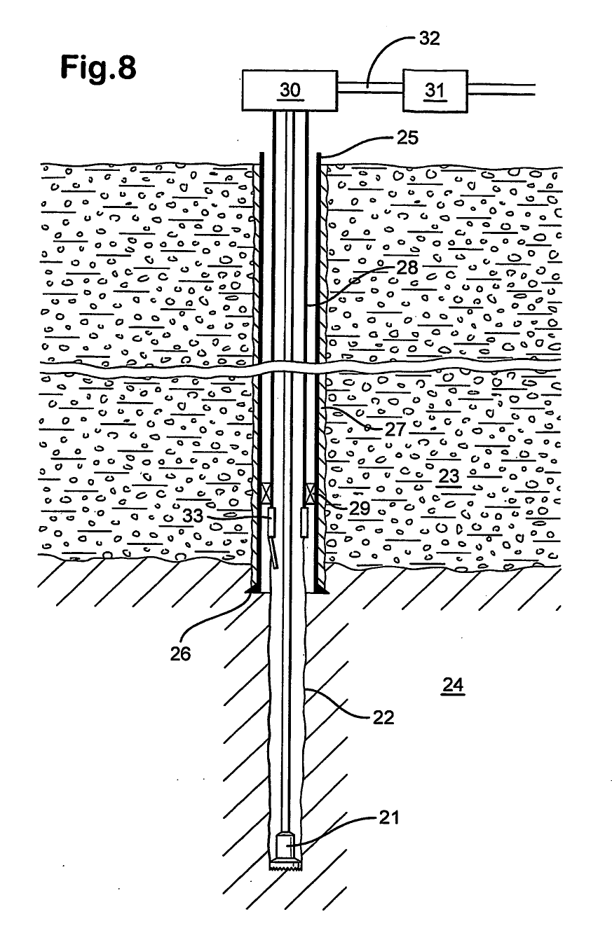

FIG. 8 is a schematic representation of the basic elements of the method and apparatus according to the present invention.

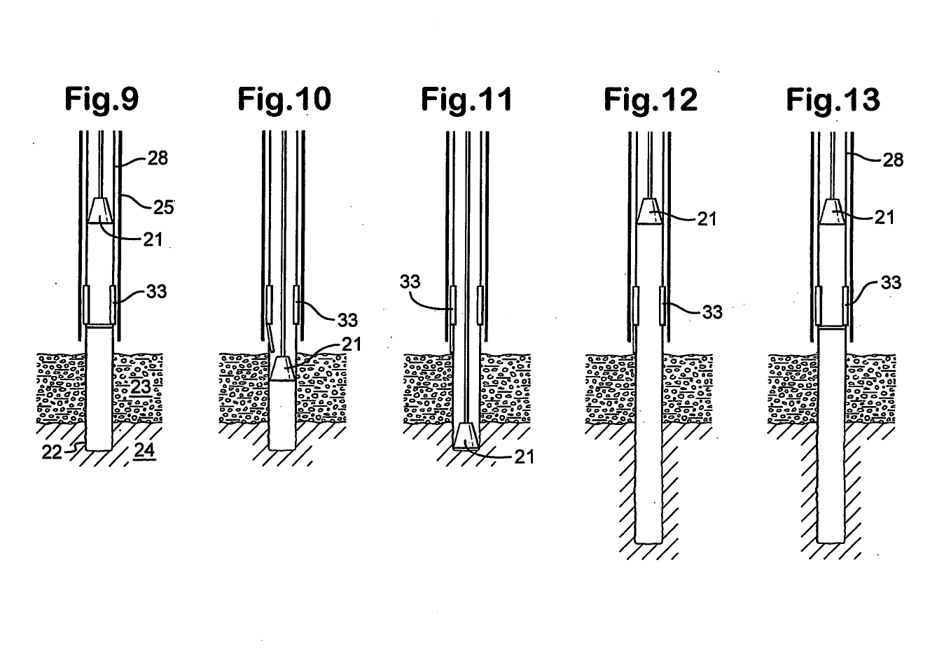

FIGS. 9 to 13 are schematic representations of underbalanced drilling using a deployment valve according to the present invention.

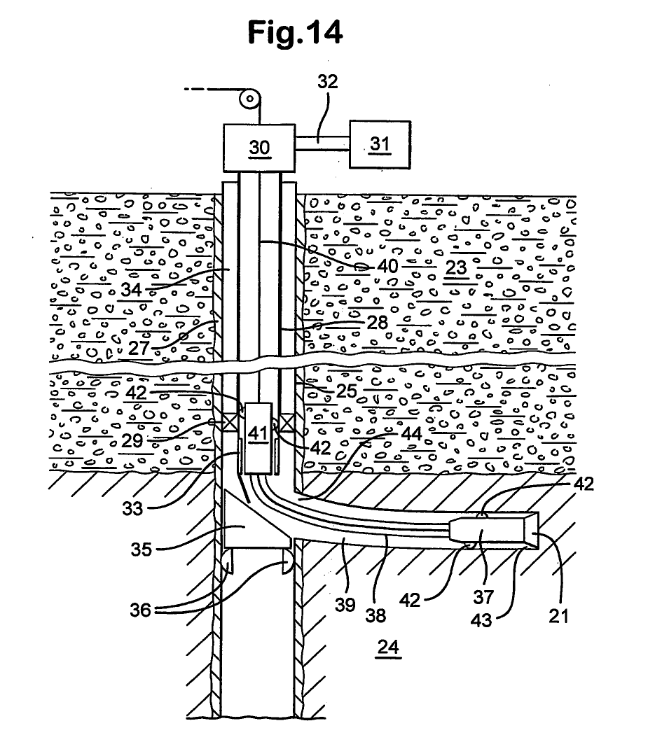

FIG. 14 is a schematic representation of an existing wellbore which penetrates into a reservoir formation from which existing wellbore a new wellbore is being drilled under underbalanced drilling conditions.

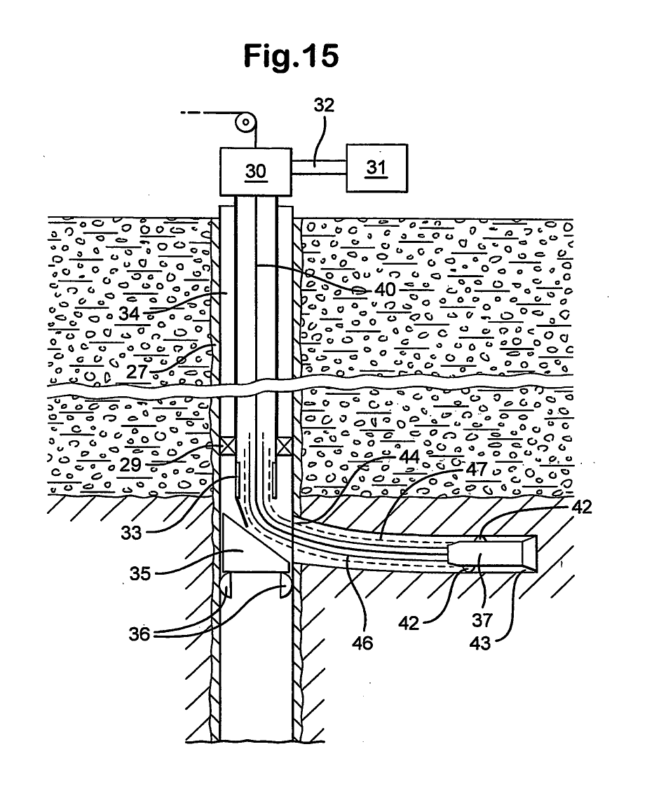

FIG. 15 is a schematic representation of an existing wellbore which penetrates into a reservoir formation from which existing wellbore, a new wellbore is being drilled under underbalanced drilling conditions and in which a sandscreen is installed.

FIGS. 1 to 3 show a deployment valve according to the present invention. The valve comprises a tubular body 1 and a flapper valve element 2. The tubular body 1 is radially expandable and comprises a substantially cylindrical section 3 and a deformed section 4 which comprises a fold in the wall of the tubular body. The flapper valve element 2 has a sealing surface 5 and a reinforcing portion 6 and is mounted on a support bracket 7 via a pin 8 about which the flapper valve element 2 can be rotated. The support bracket 7 is attached to the tubular body 1 within the fold of the deformed section 4. The mounting of the flapper valve element 2 in this manner means that it is positioned towards the central axial plane 9 of the tubular body 1. As seen more clearly in FIGS. 2 and 3, this positioning and the slightly curved shape of the flapper valve element 2 means that the flapper valve element is substantially the same width as the outer diameter of the substantially cylindrical section 3 of the tubular body 1. The curve of the flapper valve element (2) has brought the edges of the valve element towards each other, thereby reducing the maximum dimension of the valve element transverse to the longitudinal axis of the tubular body of the deployment valve, i.e. the distance across the valve element as shown in FIG. 2 is less than the diameter that the valve element will have when operational with the sealing surface (5) substantially flat. An elastomeric seal 10 is positioned on the end of the tubular body against which the flapper valve element will close. When the deployment valve is radially expanded as further described below, the deformed portion 4 is reformed to a substantially circular cross-section and the diameter of the whole of the tubular body 1 can be increased. Reformation of the deformed portion 4 moves the support bracket radially outwardly such that when the flapper valve element 2 is closed against the end of the tubular body 1, it forms a seal against the elastomeric seal 10.

FIGS. 4 to 6 show a flapper valve molding. The valve can be molded from any suitable material, for example an elastomeric material which is essentially inert to fluids in the wellbore. In the figures, the flapper valve element has not yet been cut out from the molding. Thus the four corners 11, 12, 13 and 14 would be cut away leaving the substantially circular flapper valve element 2 with a connecting arm 15. The flapper valve element 2 has a sealing surface 16 and a reinforcing portion 17. The reinforcing portion 17 provides sufficient strength for the flapper valve to resist the downhole pressure, but provides sufficient flexibility to allow the flapper valve element 2 to be curved as shown in FIGS. 1 to 3 to facilitate installation. The curvature could be provided during manufacture, by subsequent treatment or may be achieved by physically deforming and restraining the flapper valve element during installation.

FIG. 7 illustrates a flapper valve similar to that shown in FIGS. 4 to 6 except that it is produced by welding rather than moulding. The flapper valve element comprises a sealing plate 18 to which reinforcing elements 19 have been welded as shown by welds 20. Preferably, the flapper valve element is made of stainless steel. It is possible that the welding of the reinforcing elements 19 to the sealing plate may cause some distortion of the sealing plate. Generally, flapper valves require a substantially flat surface on the flapper valve element to achieve a good seal with the valve body. It might have been expected that any distortion would have an unacceptable impact on the sealing quality of the valve. However, it has been found that the flexibility provided by the design of the plate and welded reinforcing elements allows a good seal to be achieved.

A flapper valve element similar to those illustrated in FIGS. 4 to 7 could also be produced by machining from a block of material.

In any of the moulded, welded or machined designs of flapper valve element, the dimensions of the reinforcing elements, their spacing and the thickness of the sealing surface or plate will depend on the overall dimensions of the valve and the pressures to be contained.

FIG. 8 is an elevational schematic view of an underbalanced wellbore operation. A drill bit 21 is shown at the bottom of a wellbore 22 and is drilling in open hole. The wellbore has been drilled through a first formation 23 until a reservoir formation 24 was reached. Casing 25 with a casing shoe 26 at its lower end has been arranged in the wellbore and fixed in position with cement 27. A production tubing 28 has been installed within the casing 25 which is provided at its lower end with an inflatable packer 29. A well head 30 at the surface provides fluid communication between the production tubing 28 and a hydrocarbons processing facility 31 via pipeline 32. The well head 30 comprises the usual equipment for controlling the flow of fluids from a well, including safety valves and blow out preventers. At the end of the production tubing 28 is a deployment valve 33. The deployment valve is a flapper valve and the valve element is show in the open position. The deployment valve has been installed by passing the deployment valve down through the production tubing and then expanding the tubular body of the deployment valve to fix it to the bottom of the production tubing 28. As drilling continues into the reservoir formation, production fluids flow into the wellbore 22, up the production tubing 28 to the wellhead 30 and thence to the processing facility 31 via pipeline 32.

FIGS. 9 to 13 illustrate the use of a deployment valve in underbalanced drilling. Elements common with the wellbore shown in FIG. 8 have the same numerals. Thus, in FIG. 9, the wellbore is lined with casing 25 within which is positioned a production tubing 28 having a deployment valve 33 at the lower end thereof. The deployment valve 33 is located at a well depth which is significantly below the string light position for the drill string. The wellbore 22 has been drilled through formation 23 into reservoir formation 24. The flapper valve element of the deployment valve 33 is closed. The drill string and drill bit 21 have been tripped into the well bore conventionally until the drill bit 21 is positioned above the closed deployment valve 33. At the surface, the pipe rams (not shown) are closed and the production tubing is pressurized up to the pressure in the wellbore at the location of the deployment valve 33. As shown in FIG. 10, the flapper valve element of the deployment valve 33 is opened. At the surface, the well will be allowed to flow to reduce the surface pressure to a safe flowing pressure. The pipe rams (not shown) are opened and the drill string and drill bit 21 are tripped further into the well bore. In FIG. 11, the drill bit 21 has reached the end of the wellbore and drilling has commenced, with the deployment valve 33 open. In FIG. 12, the drill string is being withdrawn from the well. The drill string and drill bit 21 have been withdrawn to a position above the deployment valve 33. Since the deployment valve 33 is positioned significantly below the string light position for the drill string, there is little risk of the formation pressure causing the drill string to move upwardly. In FIG. 13, the deployment valve 33 is closed and the pressure within the production tubing 28 is reduced. Isolating and reducing the pressure within the production tubing 28 from the formation pressure in this manner allows the drill string and bit 21 to be tripped out of the well conventionally and safely.

FIG. 14 is an illustration of an existing wellbore which penetrates into a reservoir formation from which existing wellbore a new wellbore is being drilled under underbalanced drilling conditions. Similar elements to the wellbore shown in FIG. 8 have the same reference numerals.

An existing wellbore 34 penetrates through an upper formation 23 and into a hydrocarbon-bearing formation 24. A metal casing 25 is arranged in the existing wellbore 34 and is fixed to the wellbore wall by a layer of cement 27. A production tubing 28 is positioned within the existing wellbore 34 and an inflatable packer 29 is provided at the lower end of the production tubing 28 to seal the annular space formed between the production tubing 28 and the casing 25. Positioned at the end of the production tubing 28 is a deployment valve 33 according to the present invention. The deployment valve 33 is installed by passing the deployment valve 33 through the production tubing 28 and then radially expanding the deployment valve so that it locates on the lower portion of the production tubing. A wellhead 30 at the surface provides fluid communication between the production tubing 28 and a hydrocarbon fluid processing facility 31 via a pipe 32. An expandable whipstock 35 is passed through the production tubing 28 and is locked in place in the casing 25 of the existing wellbore 34 via radially expandable locking means 36. Instead of the tubular drill string represented in FIG. 8, the apparatus illustrated in FIG. 14 utilises a wireline drill string. A remotely controlled electrically operated drilling device 37 is passed into the existing wellbore through the production tubing 28 suspended on a reinforced steel cable 40 comprising at least one electrical conductor wire or segmented conductor (not shown). The lower end of the reinforced steel cable 40 passes through a length of steel tubing 38 which is in fluid communication with a fluid passage (not shown) in the drilling device 37. The drilling device 37 is provided with an electrically operated steering means, for example, a steerable joint (not shown) and an electric motor (not shown) arranged to drive a means (not shown) for rotating drill bit 21 located at the lower end of the drilling device 37. A cylindrical housing 41 is attached to the upper end of the steel tubing 38. The drilling device 37 and/or the housing 41 are provided with an electrically operated pump (not shown) and electrically operated traction wheels or pads 42 which are used to advance the drilling device 37 through a new wellbore section 43. The cable 40 passes through the housing 41 and the interior of the steel tubing 38 to the drilling device 37.

The new wellbore section 43 is drilled using the drilling device 37, the new wellbore section 43 extending from a window 44 in the casing 25 of the existing wellbore 34 into the hydrocarbon-bearing zone 24 and being a side-track well or lateral well. The window 44 may have been formed using a drilling device comprising a mill which is passed through the production conduit 28 suspended on a cable and is then pulled from the existing wellbore. During drilling of the new wellbore section 43, produced fluid may be pumped down the interior of the steel tubing 38 to the drilling device 37 via a pump located in the cylindrical housing 41. The produced fluid flows from the steel tubing 38 through the fluid passage in the drilling device to the drill bit 21 where the produced fluid serves both to cool the drill bit 21 and to entrain drill cuttings. The drill cuttings entrained in the produced fluid are then passed around the outside of the drilling device 37 into the annulus 39 formed between the steel tubing 38 and the wall of the new wellbore section 43 (“conventional circulation” mode). Alternatively, produced fluid may be pumped through the annulus 39 to the drill bit 21. The drilling cuttings entrained in the produced fluid are then passed through the passage in the drilling device and into the interior of the steel tubing 38 (“reverse circulation” mode).

A plurality of formation evaluation sensors (not shown) may be located: on the drilling device 37 in close proximity to the drill bit 21; on the end of the steel tubing 38 which is connected to the drilling device 37; along the lower end of the cable 40 that lies within the steel tubing 38; and/or along the outside of the steel tubing. The formation evaluation sensors are electrically connected to recording equipment (not shown) at the surface via electrical wire(s) and/or segmented conductor(s) which extend along the length of the cable 40. Where sensors are located on the outside of the steel tubing, the sensors may be in communication with the electrical wire(s) and/or segmented conductor(s) of the cable 40 via electromagnetic means. As drilling with the drilling device 37 proceeds, the formation evaluation sensors are operated to measure selected formation characteristics and to transmit signals representing the characteristics via the electrical conductor wire(s) and/or segmented conductor(s) of the cable 40 to recording equipment at the surface (not shown).

A navigation system (not shown) for the steering means may also be included in the drilling device 37 to assist in navigating the drilling device 37 through the new wellbore section 43.

The steel tubing 38 may be expandable tubing. After drilling of the new wellbore section 43, the expandable steel tubing 38 may be radially expanded to form a liner for the new wellbore section 43 and the drilling device 37 may be retrieved by pulling the cable from the wellbore and/or by actuating the traction wheels or pads 42 such that the drilling device passes through the expanded steel tubing and the hydrocarbon fluid production conduit 28. Methods and apparatus for installing expandable tubulars in oil and gas wells are known and any such methods may be used in the present invention.

Where the steel tubing 38 is not expandable, the steel tubing 38 may be provided with at least one radially expandable packer. The packer(s) may be expanded to seal the annulus formed between the steel tubing 38 and the new wellbore section 43 thereby forming a sealed liner for the new wellbore section 43. Where a pump is located in the housing of the drilling device 37, this pump may be disconnected from the housing and may be retrieved through the interior of the steel tubing 38.

The liner for the new wellbore section may then be perforated to allow hydrocarbons to flow through the interior thereof into the production conduit 28.

The new wellbore section 43 can be relatively long, typically in excess of a kilometre. Installing the steel tubing 38 in a producing well can present difficulties, especially if it is desired not to kill the well.

An effective seal can be made around solid steel pipe or coiled tubing. Thus, the conventional methods for introducing pipe strings into a well can be used if the steel tubing 38 is sufficiently strong. However, it would be preferable to use flexible tubing for the tubing 38. Coiled tubing and solid tubing are both relatively heavy and relatively expensive and costly to deploy. Although, lighter, lower cost and less stiff polymer tubes could be used as the tubing 38, it can be difficult to introduce it into the well. Being lighter, it may become string light at a much shallower depth. Also it is not easy to seal around the pipe at the surface.

As indicated above, when introducing tools or drilling on wireline, the downhole assembly can be made up above the sealing valves which are present in the so-called Christmas tree at the surface of the wellbore. The length of tubing which accommodates the downhole assembly prior to introducing it into the wellbore via the Christmas tree is generally called a lubricator. The lubricator is generally only about 30 to 40 feet long (9 to 12 m). It is therefore not possible to introduce long lengths of tubing using only the lubricator. In most wells there is a further safety valve positioned about 500 to 1000 ft (150 to 300 m) below the surface. The length of wellbore above this sub-surface safety valve could be used to assemble the steel tubing 38 so that it could be lowered into the well. However, this section is still relatively short. Furthermore, since it is not easy to effectively seal around the supporting wire in wireline drilling or around a flexible pipe, it would be preferable not to have the valves in the Christmas tree open whilst relying on the sub-surface safety valve as the sole valve for holding back the well pressure.

The use of the deployment valve according to the present invention allows long lengths of flexible tubing 38 to be introduced into the wellbore for introduction into the new wellbore section 43 in the manner described with reference to FIG. 14. By withdrawing the wireline drilling apparatus to above the deployment valve 33 and closing the valve, the pressure in the production tubing can be reduced to a safe operating pressure. The steel tubing can then be introduced into the wellbore without risk of it encountering string light conditions. The deployment valve 33 may be at a depth in excess of 1 km, possibly greater than 3 kilometres. This provides sufficient length for the introduction of a relatively long length of steel tubing 38. Effectively, the production tubing 28 and deployment valve 33 act as a very long lubricator. After introducing the steel tubing 38 into the wellbore, the pressure within the production tubing 28 above the closed deployment valve 33 can be increased and then the deployment valve is opened to allow passage of the wireline drilling apparatus and steel tubing 38 to the new wellbore section 43. Production fluids can then continue to be withdrawn via the production tubing 28.

FIG. 15 is similar to FIG. 14 and the same elements have the same reference numerals, but instead of steel tubing 38 there is provided plastic tubing 46 and a sandscreen 47. The plastic tubing 46 is in fluid communication with a fluid passage (not shown) in the drilling device 37. The sandscreen 47 is positioned around the plastic tubing 46 and is releasably connected to the drilling apparatus 37. The plastic tubing 46 can, like the steel tubing 38 in FIG. 14, be used to transport fluid to or from the drilling apparatus 37. After drilling of the new wellbore section 43, the sandscreen may be expanded, for example, by sealing the plastic tubing 46 and pressurising with fluid to expand the plastic tubing 46 which in turn expands the sandscreen 47. By releasing the pressure in the plastic tubing 46, it will deflate sufficient to allow its withdrawal from the sandscreen 47.

1-11. (canceled)

12. A sub-surface deployment valve comprising a radially expandable body having an internal bore and a valve element capable of closing off the internal bore.

13. A deployment valve as claimed in claim 12, comprising a radially expandable tubular body having a flapper valve element attached to the expandable tubular body at one end thereof by pivot connections.

14. A deployment valve as claimed in claim 13 in which the expandable tubular body has a folded or deformed wall at least adjacent the flapper valve element such that the pivot means is accommodated within the folded wall and supports the flapper valve element in the open position, such that its widest dimension is positioned towards the central axial plane of the tubular body

15. A deployment valve as claimed in claim 13 in which the flapper valve element is substantially circular and deformable so that it can be passed through a tube of smaller diameter.

16. A deployment valve as claimed in claim 13 in which the flapper valve element comprises a sealing surface and a reinforcing portion which is attached to or integrally formed with the sealing surface, the reinforcing portion comprising substantially parallel ribs the longitudinal axis of which are in the same axis as the longitudinal axis of the tubular body, when the valve element is in the open position.

17. A method for drilling a wellbore having located within the wellbore a tubular string comprises positioning a deployment valve at least partially within the tubular string such that, once the deployment valve is installed, a drill string can be moved through the deployment valve wherein the deployment valve comprises a radially expandable body with an internal bore and a valve element capable of closing off the internal bore, the method further comprising attaching the deployment valve to or in the tubular string by radially expanding the radially expandable body of the deployment valve to form a connection resulting from the interference between the external surface of the deployment valve and the tubular string

18. A method as claimed in claim 17 in which the tubular string is production tubing.

19. A method as claimed in claim 17 in which the deployment valve comprises a radially expandable tubular body having attached thereto a flapper valve element.

20. A method as claimed in claim 17 in which the drilling is carried out under underbalanced conditions and the deployment valve is located below the string light position of the drill string.

21. A method as claimed in claim 20 in which the drill string can be removed from the wellbore by withdrawing the drill string into the production tubing, to a position where the lower part of the drill string is above the deployment valve, but below the drill light position, closing the deployment valve and reducing the pressure within the production tubing.

22. A method as claimed in claim 17 for drilling a borehole from a selected location in an existing wellbore penetrating a subterranean earth formation having at least one hydrocarbon fluid bearing zone wherein the existing wellbore is provided with at least one surface valve, a casing and a hydrocarbon fluid production conduit arranged in the wellbore in sealing relationship with the wall of the casing, comprising:
(a) passing a remotely controlled electrically operated drilling device from the surface through the hydrocarbon fluid production conduit to the selected location in the existing wellbore;
(b) operating the drilling device such that cutting surfaces on the drilling device drill the borehole from the selected location in the existing wellbore thereby generating drill cuttings wherein during operation of the drilling device, a first stream of produced fluid flows directly to the surface through the hydrocarbon fluid production conduit and a second stream of produced fluid is pumped over the cutting surfaces of the drilling device via a remotely controlled electrically operated downhole pumping means and the drill cuttings are transported away from the drilling device entrained in the second stream of produced fluid,
wherein,
(c) a relatively long tubing is provided to convey the second stream of produced fluid to the drill bit or to carry the fluid and drill cuttings away from the drill bit, and
(d) the deployment valve is located at a depth such that when the tubing is installed or removed from the wellbore, there is a sufficient length within the production tube between the surface valve and the deployment valve to accommodate the relatively long tubing.
